(19) United States
(12) Patent Application Publication
(10) Pub. No.: US 2010/0301170 A1
(43) Pub. Date: Dec. 2, 2010

(54) CONTROL SYSTEM FOR ACTUATION SYSTEM

(76) Inventors: Arin Boseroy, San Marino, CA (US); Greg A. Tengan, Orange, CA (US)

Correspondence Address: MERCHANT & GOULD PC, P.O. BOX 2903, MINNEAPOLIS, MN, 55402-0903, US

(21) Appl. No.: 12/475,123

(22) Filed: May 29, 2009

(51) Int. Cl. G05D 1/00

(52) U.S. Cl. 244/194

(57) ABSTRACT

A method for controlling a plant assembly includes providing a plant assembly having a first plant including a first sensor that monitors the first plant. The plant assembly further includes a second plant in communication with the first plant. The second plant includes a second sensor that monitors the second plant. The method further includes providing a controller that is adapted to control the plant assembly. An outer control loop of the controller receives a setpoint and a feedback signal, which is provided by the second sensor. A first control output signal is communicated from the outer control loop to an inner control loop of the controller. The inner control loop receives the first control output signal and a feedback signal, which is provided by the first sensor of the first plant. An output signal is provided to the first plant.

### BACKGROUND

Actuators are used on various applications and are typically controlled by some type of input device (e.g., joystick, pedal, steering wheel, etc.). For example, aircrafts use various actuators. One such actuator on an aircraft is used for steering a nose wheel of the aircraft during ground transportation. The actuator is manually actuated with an actuation mechanism (e.g., tiller, pedal, etc.) disposed in the cockpit of the aircraft.

A controller interprets signals from the actuation mechanism and communicates those signals to the actuator. However, there is currently a need for a control scheme that is more precise and responsive to the commands of the operator.

### SUMMARY

An aspect of the present disclosure relates to a method for controlling a plant assembly. The method includes providing a plant assembly having a first plant including a first sensor that monitors the first plant. The plant assembly further includes a second plant in communication with the first plant. The second plant includes a second sensor that monitors the second plant. The method further includes providing a controller that is adapted to control the plant assembly. An outer control loop of the controller receives a setpoint and a feedback signal, which is provided by the second sensor. A first control output signal is communicated from the outer control loop to an inner control loop of the controller. The inner control loop receives the first control output signal and a feedback signal, which is provided by the first sensor of the first plant. An output signal is provided to the first plant.

Another aspect of the present disclosure relates to a control system. The control system includes a plant assembly and a controller that is adapted to control the plant assembly. The plant assembly includes a first plant and a second plant in communication with the first plant. The controller includes a control loop having an outer control loop adapted to minimize error associated with a manipulated variable of the second plant and an inner control loop adapted to minimize error associated with a manipulated variable of the first plant. The outer control loop provides a first control output signal that is based on a feedback signal from the second plant. The inner control loop communicates an output signal to the first plant. The output signal is based on a feedback signal from the first plant and the first control output signal of the outer control loop.

Another aspect of the present disclosure relates to a steering control system. The steering control system includes a steering system and a controller that is adapted to control the steering system. The steering system includes an electro-hydraulic servo valve and a steering actuator in selective fluid communication with the electro-hydraulic servo valve. The controller includes a control loop having an outer control loop that is adapted to minimize error between a desired position of the steering actuator and an actual position of the steering actuator and an inner control loop that is adapted to minimize error between a desired position of the electro-hydraulic servo valve and an actual position of the electro-hydraulic servo valve. The outer control loop produces a first output control signal. The inner loop communicates an output signal to the electro-hydraulic servo valve based on the actual position of the electro-hydraulic servo valve and the first output control signal.

A variety of additional aspects will be set forth in the description that follows. These aspects can relate to individual features and to combinations of features. It is to be understood that both the foregoing general description and the following detailed description are exemplary and explanatory only and are not restrictive of the broad concepts upon which the embodiments disclosed herein are based.

### DRAWINGS

FIG. 1 is a schematic representation of an actuation system having exemplary features of aspects in accordance with the principles of the present disclosure.

FIG. 2 is a schematic representation of a steering system suitable for use in the actuation system of FIG. 1.

FIG. 3 is a schematic representation of a controller suitable for use with the actuation system of FIG. 1.

FIG. 4 is a schematic representation of the actuation system of FIG. 1 with the controller of FIG. 3.

### DETAILED DESCRIPTION

Reference will now be made in detail to the exemplary aspects of the present disclosure that are illustrated in the accompanying drawings. Wherever possible, the same reference numbers will be used throughout the drawings to refer to the same or like structure.

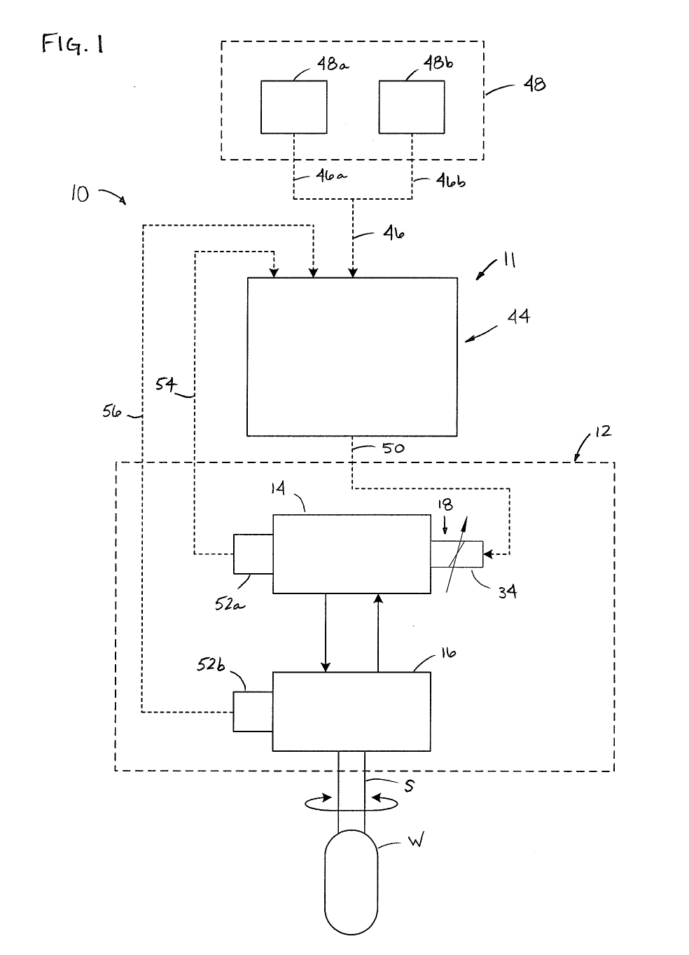

Referring now to FIG. 1, a schematic representation of an actuation system, generally designated 10, is shown. The actuation system 10 includes a control system 11 is adapted to control a plant assembly, generally designated 12. It will be understood that the term “plant” used herein and in the appended claims refers to hardware at least partially controlled by the control system 11.

The plant assembly 12 includes a first plant 14 and a second plant 16. In one aspect of the present disclosure, the second plant 16 is in fluid communication with the first plant 14 such that an output of the second plant 16 corresponds to an output of the first plant 14. For example, the first plant 14 could be a fluid pump or a valve while the second plant 16 could be a fluid motor, fluid cylinder, steering unit, etc. In another aspect of the present disclosure, the output of the second plant 16 is at least partially dependent on the output of the first plant 14. In another aspect of the present disclosure, the output of the second plant 16 is substantially dependent on the output of the first plant 14. It will be understood that the term substantially dependent accounts for any losses associated with leakage, friction, etc. of the first and second plants 14, 16 that may affect the output of the second plant 16.

In one aspect of the present disclosure, the plant assembly 12 is a steering system. It will be understood, however, that the scope of the present disclosure is not limited to the plant assembly 12 being a steering system as the plant assembly 12 could be any assembly having a first component (e.g., hydraulic, electromechanical, etc.) in communication with a second component (e.g., hydraulic, electromechanical, etc.). In another aspect of the present disclosure, the plant assembly 12 is adapted for to steer a nose wheel W of an aircraft. It will be understood, however, that the scope of the present disclosure is not limited to the plant assembly 12 being used to steer a nose wheel W of an aircraft as the plant assembly 12 could alternatively be used with various assemblies (e.g., control actuators, brake actuators, positioning systems, etc.) on various industrial and mobile applications (e.g., agriculture, construction, marine, etc.). While the scope of the present disclosure is not limited to plant assembly 12 being a steering system for a nose wheel W of an aircraft, the plant assembly 12 will be described as such for ease of description purposes.

The steering system 12 is an electro-hydraulic steering system. In one aspect of the present disclosure, the first plant 14 of the steering system 12 is a servo valve. The servo valve 14 includes an electronic pilot 18. In one aspect of the present disclosure, the electronic pilot 18 is a solenoid valve. An exemplary servo valve 14 that is suitable for use in the actuation system 10 is sold as product number 1570457 from IN-LHC, a division of Zodiac Aircraft Systems.

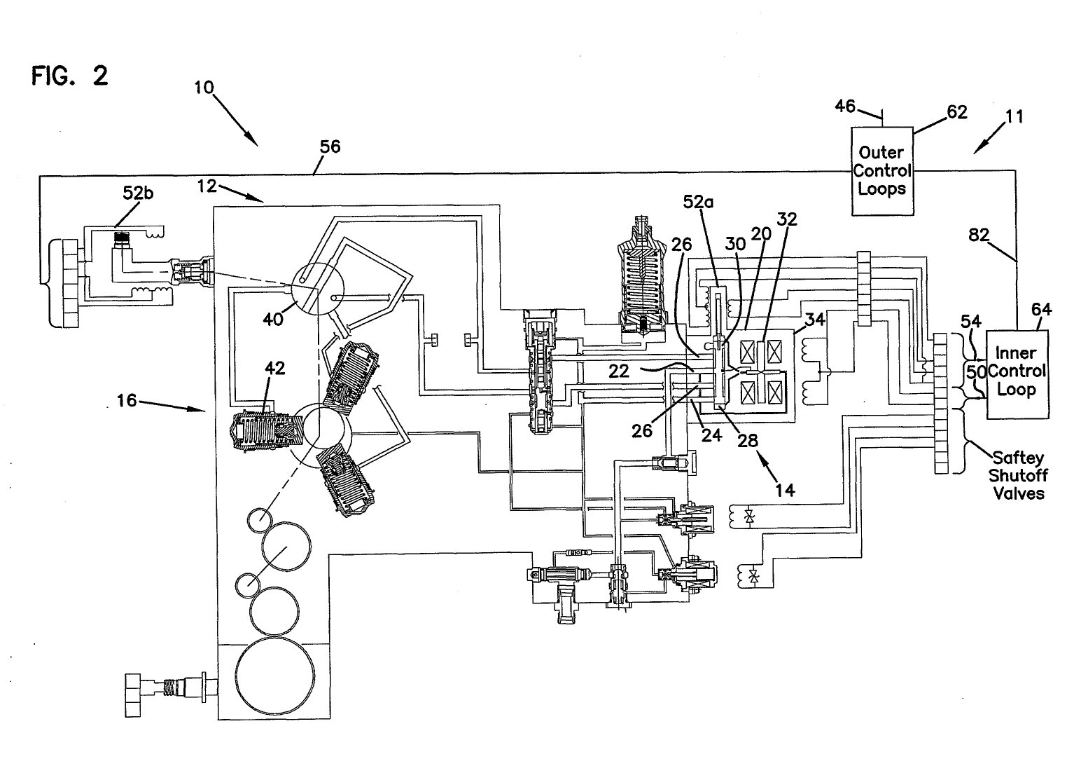

Referring now to FIG. 2, the servo valve 14 includes a housing 20 defining an inlet port 22, an outlet port 24, a plurality of control ports 26, and a bore 28. The inlet port 22 is in fluid communication with a fluid source, such as a fluid pump. In an open-loop configuration, the outlet port 24 of the servo valve 14 is in fluid communication with a fluid reservoir. In a closed-loop configuration, the outlet port 24 is in fluid communication with an inlet of the fluid pump.

The inlet, outlet and control ports 22, 24, 26 extend through the housing 20 of the servo valve 14 to the bore 28. A spool 30 is slidably disposed in the bore 28 of the servo valve 14. The spool 30 provides selective fluid communication between the inlet and outlet ports 22, 24 and the control ports 26.

In one aspect of the present disclosure, the spool 30 slides axially in the bore 28. The spool 30 is engaged to an armature 32. The spool 30 moves in response to movement of the armature 32. The armature 32 is actuated by a solenoid 34.

Referring now to FIGS. 1 and 2, the second plant 16 is a steering actuator. In one aspect of the present disclosure, the steering actuator 16 is in fluid communication with the servo valve 14. The steering actuator 16 rotates the nose wheel assembly of the aircraft in response to fluid communicated to the steering actuator 16 from the servo valve 14.

The steering actuator 16 includes a commutating valve 40 that is in fluid communication with a plurality of pistons 42. The commutating valve 40 receives fluid from the control ports 26 of the servo valve 14. In response to the fluid received from the servo valve 14, the commutating valve 40 of the steering actuator 16 communicates fluid to the plurality of pistons 42. The plurality of pistons 42 act on a shaft S that is connected to the nose wheel W of the aircraft to steer the aircraft during ground travel. An exemplary steering actuator 16 suitable for use with the actuation system 10 is used on model year 2008 of the Gulfstream G550 aircraft.

Referring again to FIG. 1, the control system 11 includes a controller 44. The controller 44 is adapted to receive a setpoint and to provide an output signal 50 to the plant assembly 12. In one aspect of the present disclosure, the setpoint is an input signal 46 from an input device 48.

The input device 48 includes a first input device 48a and a second input device 48b. When the first input device 48a is actuated, the first input device 48a produces a first input signal 46a that is received by the controller 44. In one aspect of the present disclosure, the first input signal 46a is produced by a sensor (e.g., a linear variable displacement transducer, a rotary variable displacement transducer, etc.) that measures the displacement of the first input device 48a. When the second input device 48b is actuated, the second input device 48b produces a second input signal 46b that is received by the controller 44. In one aspect of the present disclosure, the second input signal 46b is produced by a sensor (e.g., a linear variable displacement transducer, a rotary variable displacement transducer, etc.) that measures the displacement of the second input device 48b.

The first and second input devices 48a, 48b are adapted for actuation by an operator. In one aspect of the present disclosure, the first and second input devices 48a, 48b are disposed in a cockpit of the aircraft and adapted for actuation by a pilot of the aircraft during ground transportation. For example, the first input device 48a can be a tiller assembly that is manually actuated by the pilot while the second input device 48b can be a rudder pedal that is manually actuated by the pilot.

The controller 44 is further adapted to receive data from a plurality of sensors 52 that is adapted to monitor the plant assembly 12. In one aspect of the present disclosure, a first sensor 52a provides data to the controller 44 related to the first plant 14 while a second sensor 52b provides data to the controller 44 related to the second plant 16.

In one aspect of the present disclosure, the first sensor 52a is adapted to provide a first feedback signal 54 to the controller 44 related to the servo valve 14. In one embodiment, the first sensor 52a is a positional sensor that is adapted to provide data regarding the axial position of the spool 30 in the bore 28 of servo valve 14. An exemplary first sensor 52a that is suitable for use with the actuation system 10 is a linear variable differential transducer (LVDT).

The second sensor 52b is adapted to provide a second feedback signal 56 to the controller 44 related to the steering actuator 16. In one embodiment, the second sensor 52b is a positional sensor that is adapted to provide data to the controller 44 regarding the rotational position of the nose wheel W. In one aspect of the present disclosure, the second sensor 52b is a linear variable differential transducer (LVDT) that measures the axial displacement of a ball screw engaged with the nose wheel assembly. In another aspect of the present disclosure, the second sensor 52b is a rotary variable differential transducer (RVDT).

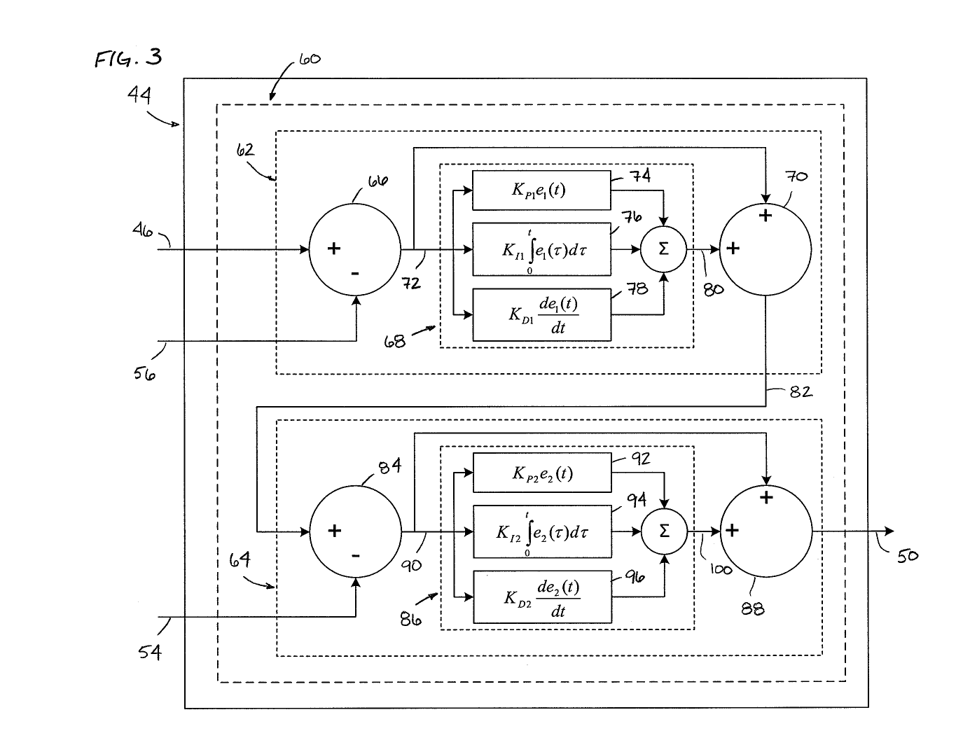

Referring now to FIG. 3, a control process 60 used by the controller 44 will be described. The control process 60 of the controller 44 is adapted to minimize the error between the desired output of the plant assembly 12 and the actual output of the plant assembly 12. The control process 60 includes an outer control loop 62 and an inner control loop 64.

The outer control loop 62 is adapted to minimize the error between a manipulated variable of the second plant 16. In one aspect of the present disclosure, the manipulated variable of the second plant 16 is the position of the nose wheel W.

In another aspect of the present disclosure, the outer control loop 62 is adapted to minimize the error between the desired output of the plant assembly 12 and the actual output of the second plant 16 of the plant assembly 12. In one aspect of the present disclosure, the outer control loop 62 stabilizes the second plant 16 of the plant assembly 12.

The outer control loop 62 includes a first subtraction unit 66, a first controller 68 and a first addition unit 70. The first subtraction unit 66 of the outer control loop 62 receives the input signal 46 from the input device 48 and the second feedback signal 56 from the second sensor 52b that monitors the second plant 16.

The first subtraction unit 66 generates a first error signal (e₁(t)) 72. The first error signal 72 is the difference between the desired output of the second plant 16 and the actual output of the second plant 16. In one aspect of the present disclosure, the first error signal 72 is the difference between the desired position and/or desired rotation of the nose wheel steering assembly and the actual position and/or actual rotation of the nose wheel steering assembly.

The first error signal 72 is received by the first controller 68. The first controller 68 is a proportional-integral-derivative (PID) controller. The first controller 68 includes a first proportional term 74, a first integral term 76 and a first derivative term 78.

The first proportional term 74 multiplies the first error signal 72 by a first proportional gain constant K_{P1}. The first proportional term 74 is governed by the equation K_{P1}e(t).

The first integral term 76 integrates the first error signal 72 over a given time interval t. The integrated error is then multiplied by a first integral gain K_{I1}. The first integral term 76 is governed by the equation

$${K}_{I 1} {\int }_{0}^{t} e ( τ ) d τ .$$

The first derivative term 78 determines the rate of change in first error signal 72 over time. The rate of change is multiplied by a first derivative gain K_{D1}. The first derivative term 78 is governed by the equation

$${K}_{D 1} \frac{d {e}_{1} ( t )}{d t} .$$

The first proportional term 74, the first integral term 76 and the first derivative term 78 are summed to provide a first controller output signal 80. The first controller output signal 80 of the first controller 68 and the first error signal 72 are received by the first addition unit 70. The first addition unit 70 combines the first controller output signal 80 and the first error signal 72 to generate a first output control signal 82 of the outer control loop 62.

The inner control loop 64 is adapted to minimize the error of a manipulated variable of the first plant 14. In one aspect of the present disclosure, the manipulated variable of the first plant 14 is the position of the spool 30 in the bore 28.

In another aspect of the present disclosure, the inner control loop 64 is adapted to minimize the error between the desired output of the plant assembly 12 and the actual output of the first plant 14 of the plant assembly 12. In one aspect of the present disclosure, the inner control loop 64 stabilizes the first plant 14 of the plant assembly 12.

The first output control signal 82 of the outer control loop 62, which is based on the difference between the desired output of the second plant 16 and the actual output of the second plant 16, is received by the inner control loop 64. The inner control loop 64 includes a second subtraction unit 84, a second controller 86 and a second addition unit 88.

The second subtraction unit 84 receives the first output control signal 82 of the outer control loop 62 and the first feedback signal 54 of the first sensor 52a that monitors the first plant 14.

The second subtraction unit 84 generates a second error signal (e₂(t)) 90. The second error signal 90 is the difference between the first output control signal 82 of the outer control loop 62 and the actual output of the first plant 14.

The second error signal 90 is received by the second controller 86. The second controller 86 is a proportional-integral-derivative (PID) controller. The second controller 86 includes a second proportional term 92, a second integral term 94 and a second derivative term 96.

The second proportional term 92 multiplies the second error signal 90 by a second proportional gain constant K_{P2}. The second proportional term 92 is governed by the equation K_{P2}e(t).

The second integral term 94 integrates the second error signal 90 over a given time interval t. The integrated error is then multiplied by a second integral gain K_{I2}. The second integral term 94 is governed by the equation

$${K}_{I 2} {\int }_{0}^{t} e ( τ ) d τ .$$

The second derivative term 96 determines the rate of change in the second error signal 90 over time. The rate of change is multiplied by a second derivative gain K_{D2}. The second derivative term 96 is governed by the equation

$${K}_{D 2} \frac{d {e}_{1} ( t )}{d t} .$$

The second proportional term 92, the second integral term 94 and the second derivative term 96 are summed to provide a second controller output 100. The second controller output 100 of the second controller 86 and the second error signal 90 are received by the second addition unit 88. The second addition unit 88 combines the second controller output 100 and the second error signal 90 to generate the output signal 50 of the controller 44.

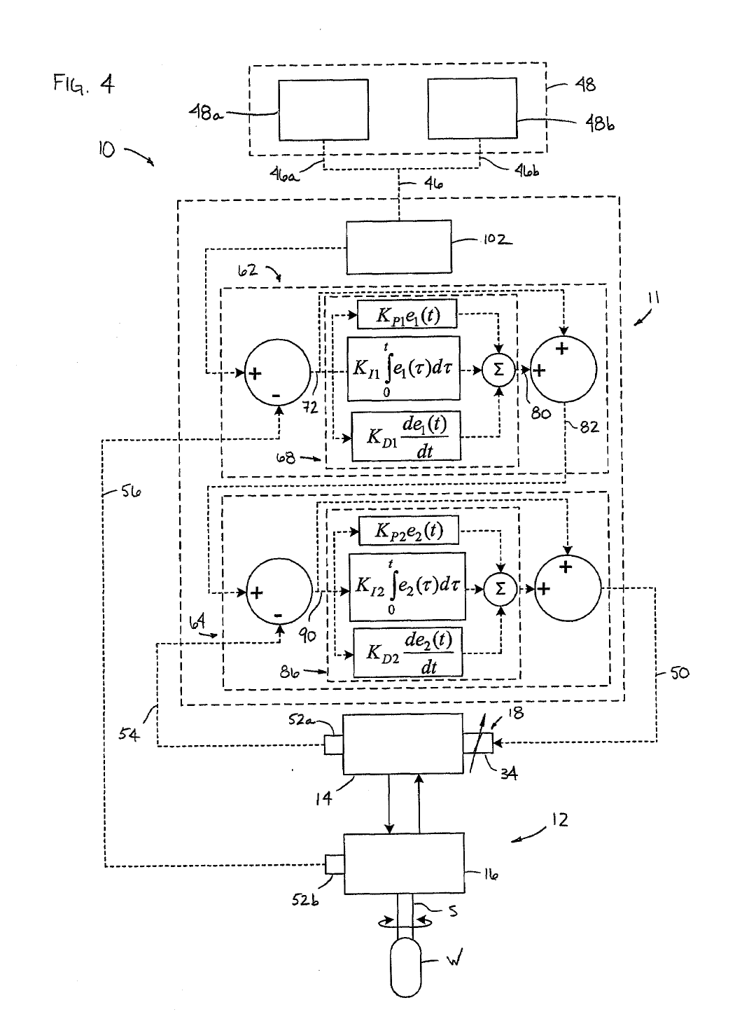

Referring now to FIGS. 2 and 4, a method for controlling a nose wheel steering assembly of an aircraft will be described. When a pilot or operator actuates the tiller assembly 48a or the rudder pedal 48b of an aircraft in order to steer the nose wheel W of the aircraft during ground transportation, the input signal 46 is communicated to the controller 44.

The controller 44 receives the input signal 46 from the input device 48. In one aspect of the present disclosure, the controller 44 includes a filter 102 that filters the input signal 46 from the input device 48. In one embodiment, the filter 102 filters the input signal 46 based on a pilot feel curve, which is based on parameters of the aircraft, ground speed based wheel angle clamp, and a rate limiter, which limits the rate at which changes in the steering system can occur.

The controller 44 further receives the second feedback signal 56 from the steering actuator 16. The input signal 46 and the second feedback signal 56 are received by the outer control loop 62 of the controller 44, which is adapted to stabilize the steering actuator 16 of the steering system 12. The outer control loop 62 generates the first error signal 72, which is based on the input signal 46 and the second feedback signal 56 which provides the measured position of the steering actuator 16. The first controller 68 processes the first error signal 72 using PID control theory and generates the first controller output signal 80. The outer control loop 62 generates the first output control signal 82 based on the first controller output signal 80.

The first output control signal 82 is then received by the inner control loop 64 of the controller 44. The inner control loop 64 generates the second error signal 90, which is based on the first output control signal 82 and the first feedback signal 54 which provides the measured position of the spool 30 in the bore 28 of the servo valve 14. The second controller 86 processes the second error signal 90 using PID control theory and generates the output signal 50.

The output signal 50 is communicated to the solenoid 34 of the servo valve 14. In response to the output signal 50, the armature 32 of the solenoid 34 is actuated which causes movement of the spool 30 inside the bore 28 of the servo valve 14. As the spool 30 slides axially in the bore 28 of the servo valve 14, the first sensor 52a sends the first feedback signal 54 to the inner control loop 64 of the controller 44. In response to the first feedback signal 54, the inner control loop 64 makes corresponding adjustments to the output signal 50.

As the spool 30 slides axially in the bore 28, fluid is communicated between the inlet and outlet ports 22, 24 and the control ports 26 of the housing 20 of the servo valve 14. Fluid from the control ports 26 is communicated to the commutating valve 40 of the steering actuator 16. In response to fluid communicated to the commutating valve 40, the commutating valve 40 communicates fluid to the plurality of pistons 42, which act on the shaft S to rotate the nose wheel W. As the nose wheel W rotates, the second sensor 52b sends the second feedback signal 56 to the outer control loop 62 of the controller 44. In response to the second feedback signal 56, the outer control loop 62 makes corresponding adjustments to the first output control signal 82 that is provided to the inner control loop 64.

In one aspect of the present disclosure, the control system 11 continues to function in the event of a failure/malfunction of the first sensor 52a. If the first sensor 52a fails or malfunctions, the first sensor 52a is unable to provide feedback data to the inner control loop 64 of the control process 60 regarding the first plant 14 of the plant assembly 12. In this situation, however, the second sensor 52b continues to provide feedback data related to the second plant 16 of the plant assembly 12 to the outer control loop 62. Therefore, the outer control loop 62 will govern the control process 60 of the controller 44.

Various modifications and alterations of this disclosure will become apparent to those skilled in the art without departing from the scope and spirit of this disclosure, and it should be understood that the scope of this disclosure is not to be unduly limited to the illustrative embodiments set forth herein.

What is claimed is:

1. A method for controlling a plant assembly, the method comprising:
providing a plant assembly including:
a first plant having a first sensor that monitors the first plant;
a second plant being in communication with the first plant, the second plant having a second sensor that monitors the second plant;
providing a controller adapted to control the plant assembly;
receiving a setpoint and a feedback signal into an outer control loop of the controller, wherein the feedback signal is provided by the second sensor;
communicating a first control output signal from the outer control loop to an inner control loop of the controller;
receiving the first control output signal and a feedback signal into the inner control loop of the controller, wherein the feedback signal is provided by the first sensor of the first plant; and
providing an output signal to the first plant.

2. The method of claim 1, wherein the setpoint is an input signal from an input device.

3. The method of claim 2, wherein the input device is a tiller assembly.

4. The method of claim 1, wherein the plant assembly is a steering assembly for a nose wheel of an aircraft.

5. The method of claim 4, wherein the first plant is a servo valve and the second plant is a steering actuator.

6. The method of claim 5, wherein the steering actuator includes a commutating valve in selective fluid communication with a plurality of pistons.

7. The method of claim 1, wherein each of the outer and inner control loops includes a proportional-integral-derivative controller.

8. The method of claim 1, wherein the first sensor is a linear variable displacement transducer.

9. An actuation system comprising:
a plant assembly including:
a first plant;
a second plant in communication with the first plant;
a control system having a controller adapted to control the plant assembly, the controller including a control loop having:
an outer control loop adapted to minimize error associated with a manipulated variable of the second plant, the outer control loop providing a first control output signal, wherein the first control output signal is based on a feedback signal from the second plant; and
an inner control loop adapted to minimize error associated with a manipulated variable of the first plant, the inner control loop communicating an output signal to the first plant, wherein the output signal is based on a feedback signal from the first plant and the first control output signal of the outer control loop.

10. The actuation system of claim 9, wherein the outer and inner control loops include a proportional-integral-derivative controller.

11. The actuation system of claim 9, wherein the first control output signal is further based on an input signal from an input device.

12. The actuation system of claim 9, wherein the first plant is an electro-hydraulic servo valve.

13. The actuation system of claim 12, wherein the manipulated variable of the first plant is an axial position of a spool disposed in a bore of the electro-hydraulic servo valve.

14. The actuation system of claim 12, wherein the output signal of the inner control loop is communicated to a solenoid of the electro-hydraulic servo valve.

15. A steering control system comprising:
a steering system having:
an electro-hydraulic servo valve;
a steering actuator in selective fluid communication with the electro-hydraulic servo valve;
a controller adapted to control the steering system, the controller including a control loop having:
an outer control loop adapted to minimize error between a desired position of the steering actuator and an actual position of the steering actuator, the outer control loop producing a first output control signal; and
an inner control loop adapted to minimize error between a desired position of the electro-hydraulic servo valve and an actual position of the electro-hydraulic servo valve, the inner control loop communicating a control signal to the electro-hydraulic servo valve based on the actual position of the electro-hydraulic servo valve and the first output control signal.

16. The steering control system of claim 15, wherein a first sensor provides a first feedback signal to the inner control loop that corresponds to the actual position of the electro-hydraulic servo valve.

17. The steering control system of claim 16, wherein the first sensor is a linear variable displacement transducer.

18. The control system of claim 15, wherein a second sensor provides a second feedback signal to the outer control loop that corresponds to the actual position of the steering actuator.

19. The control system of claim 18, wherein the second sensor is a linear variable displacement transducer.

20. The control system of claim 15, wherein the steering actuator includes a commutating valve in selective fluid communication with a plurality of pistons.
